(19) United States
(12) Patent Application Publication
(10) Pub. No.: US 2025/0046480 A1
(43) Pub. Date: Feb. 6, 2025

(54) Nuclear Fuel Assembly Retrofit for Increasing Reactor Power

(71) Applicant: Wisconsin Alumni Research Foundation, Madison, WI (US)

(72) Inventor: Ben Lindley, Middleton, WI (US)

(21) Appl. No.: 18/229,901

(22) Filed: Aug. 3, 2023

(51) Int. Cl. G21C 3/322

(52) U.S. Cl. CPC G21C 3/322

(57) ABSTRACT

A reactor core having improved power output uses an irregular fuel rod spacing that nevertheless retains grid-positioned control rods allowing a retrofitting of the reactor core to existing reactors without substantial modification to the pressure vessel. Generally, the fuel rod placement deviates from a regular grid and the distance between fuel rods varies.

### STATEMENT REGARDING FEDERALLY SPONSORED RESEARCH OR DEVELOPMENT

—

### CROSS REFERENCE TO RELATED APPLICATION

—

### Background of the Invention

The present invention relates to nuclear reactors and in particular to a retrofit fuel assembly operating to increase the power output of existing nuclear reactors.

With recent increases in electricity prices and concerns about the climactic effect of burning fossil fuels, there is an increased interest in nuclear power generation. Unfortunately, many nuclear power plants have been taken off-line and it can take years to build and commission new nuclear power generation.

### SUMMARY OF THE INVENTION

The present inventor has recognized that novel packing techniques can allow additional but smaller fuel rods to be installed in existing nuclear power plants to significantly increase their power output by increasing fuel surface area. Such packing does not necessarily and typically will not increase fuel volume but can be done in a way that preserves the pre-existing location of the control rod channels and the control rod activation mechanism making it practical for low-cost retrofitting without changing the pressure vessel and its penetrations or the control rod mechanism. Generally, the packing breaks from the uniform location of the fuel rods on a regular grid with uniform spacing and yet satisfies the requirements of low resistance to water flow and evenly distributed power within the reactor core.

In this regard the present invention provides a nuclear reactor having a fuel assembly with set of vertically oriented and horizontally spaced fuel tubes providing water passage therebetween and also with a set of vertically oriented control rod guide tubes separating groups of the fuel tubes. A pressure vessel surrounds multiple fuel assemblies and a control rod mechanism communicates through the pressure vessel to move control rods into and out of the control rod guide tubes. The arrangement of the fuel tubes provides that some interior fuel tubes of the fuel assembly are arranged to be displaced from equally spaced and perpendicular grid axes.

It is thus a feature of at least one embodiment of the invention to improve power output within the constraints of reactor core design by moving interior fuel tubes, and especially those around the control rod guide tubes, off of the regular grid expected by the designers of a legacy reactor and defining configuration of the control rod activation mechanism and pressure vessel penetrations.

The separation between a central axis of given fuel tubes adjacent to control rod passageways and central axes of adjacent neighbors to the given fuel tubes may vary.

It is thus a feature of at least one embodiment of the invention to improve power output within the constraints of reactor core design by relaxing the regular spacing of the fuel tubes that might be expected to be preferred for even power distribution.

The fuel tubes may be cylinders of equal diameter.

It is thus a feature of at least one embodiment of the invention to provide a retrofit of existing legacy nuclear reactors that doesn't require a manufacture of complex shapes or varied sizes of fuel pellets.

The nuclear reactor may be a pressurized water reactor maintaining circulating water through the water passage and further providing a water circulation system for maintaining a water pressure and temperature preventing the boiling of cooling water, and the control rod passageways may be positioned at intersections of a regular grid having equal spacing in perpendicular directions. In some cases, this grid may be a regular grid providing 17 intersections in each of two perpendicular grid directions.

It is thus a feature of at least one embodiment of the invention to provide a system consistent with existing control rod structures and pressure vessel penetrations to provide a cost-effective upgrade.

A subset of fuel tubes may have triangular packing providing three adjacent fuel tubes with equal separation along non-perpendicular axes.

It is thus a feature of at least one embodiment of the invention to provide some fuel tubes with a minimum area triangular packing yet consistent with the placement of the control rods on a rectilinear grid.

In some embodiments, the nuclear reactor may be a boiling water reactor maintaining circulating water through the water passage and further providing a water circulation system for maintaining a water pressure and temperature permitting boiling of cooling water. Here, the fuel assembly provides water circulation through a center of the fuel assembly only within channels holding fuel tubes.

It is thus a feature of at least one embodiment of the invention to increase fuel capacity by the elimination of so-called “water rods” whose area can be enlisted to add fuel tubes.

These particular objects and advantages may apply to only some embodiments falling within the claims and thus do not define the scope of the invention.

### BRIEF DESCRIPTION OF THE DRAWINGS

FIG. 1 is a simplified, cutaway perspective view of a pressurized water temperature nuclear reactor having a reactor core held within a pressure vessel and also holding a control rod assembly, the reactor core made up of multiple fuel assemblies having fuel rods holding fuel and the control rod guide tubes holding control rods;

FIG. 2 is a plan cross sectional view of a single prior art fuel assembly for a pressurized water reactor (PWR) fuel assembly showing fuel rods and control rod guide tubes arranged on a regular 17×17 grid;

FIG. 3 is a figure similar to FIG. 2 showing one quadrant of a modified fuel assembly according to a first approach to increasing fuel capacity;

FIG. 4 is a figure similar to FIG. 3 showing a second approach to increasing fuel capacity;

FIG. 5 is a figure similar to FIG. 2 showing multiple fuel assemblies of a prior art boiling water reactor (BWR) each holding fuel rods and separated from each other with a cruciform control rod;

FIG. 6 is a plan cross-sectional view of a fuel assembly of FIG. 5 showing internal water rods; and

FIG. 7 is a figure similar to FIG. 6 showing elimination of the water rods by the placement of additional fuel rods per a third embodiment of the invention.

### DETAILED DESCRIPTION OF THE PREFERRED EMBODIMENT

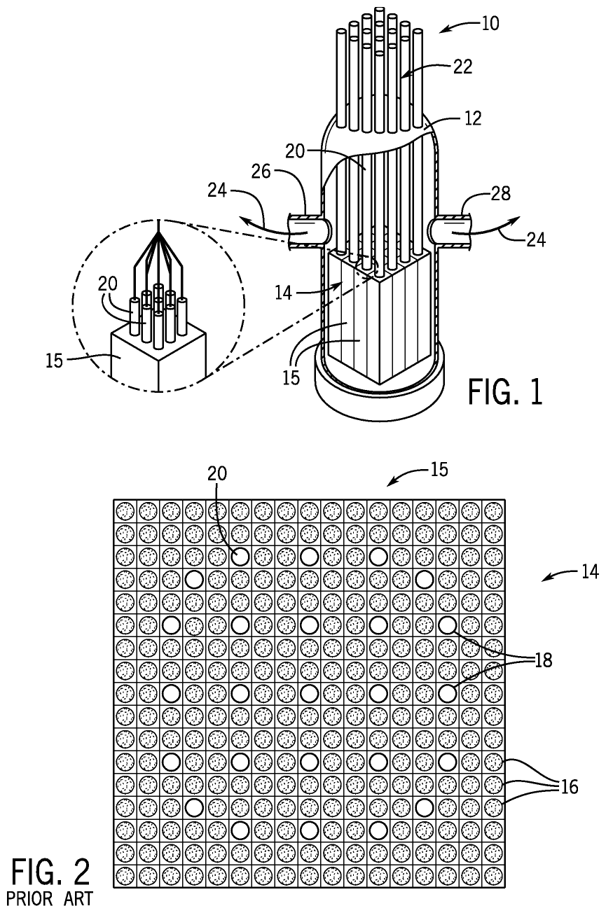

Referring now to FIGS. 1 and 2, a simplified PWR nuclear reactor 10 provides a pressure vessel 12 holding a reactor core 14 heated by a nuclear reaction. The reactor core 14 has a plurality of fuel assemblies 15 having vertically extending and horizontally spaced cylindrical openings including fuel rods 16 holding fuel pellets (not shown) and control rod guide tubes 18 holding control rods 20, Multiple control rods 20 (grouped by fuel assembly 15) may be raised and lowered within the control rod guide tubes 18 of each fuel assembly 15 by a control rod drive mechanism 22 outside of the pressure vessel communicating with the control rods 20 through the pressure vessel 12.

The pressure vessel 12 surrounds the reactor core 14 to allow circulation of pressurized water 24 into inlets 26 of the pressure vessel 12 downwardly then upwardly around the fuel rods 16 and the control rod guide tubes 18 to carry heated water of the pressure vessel 12 through outlets 28 to separate steam generators (not shown) providing steam to turbine-driven electrical generators.

In one example, the pressure vessel 12 may operate at approximately 150 atm to allow the water to reach a temperature of 325° C. without boiling. Containing this high pressure over the large volume of the pressure vessel 12 requires careful engineering of the pressure vessel 12 making retrofit modifications of the pressure vessel 12, including changing the number of openings for the control rod drive mechanism 22, impractical or costly.

Referring now to FIG. 2, a standard reactor core 14 for a PWR reactor 10 may provide 264 fuel rods 16 arranged on an equally spaced 17 column by 17 row rectangular grid. Twenty-five interspersed control rod guide tubes 18 are also arranged on the grid and spaced between groups of fuel rods 16 so as to provide for neutron controlling capabilities. This spacing of the control rod guide tubes 18 matches the mechanical configuration of the control rod drive mechanism 22 and the openings in the pressure vessel 12 which cannot be easily changed.

The fuel pellets in the fuel rods 16 are normally changed every 18 to 24 months making it feasible to change the reactor core 14 and the spacing of the fuel rods 16 therein. Generally, the spacing of the fuel rods 16 is tightly constrained by a number of factors including the need to maintain a given pressure drop of water flow through the assembly, even water flow and heating of the water among the rods, even power distribution across the reactor core 14, similar pellet diameters above the minimum dictated by vibration, and a minimum spacing between the fuel rods 16 allowing mechanical construction of the reactor core 14. Nevertheless, the present inventor has determined that within these constraints an arrangement of fuel rods 16 within the limited space of the reactor core 14 is possible that substantially increases the amount of nuclear fuel pins without changing the positioning of the control rod passageways 18.

The reactor core 14 used in the industry provides the following parameters (depicted in FIG. 1) described by Table I. These dimensions are typical although slight variations exist.

TABLE I

| fuel rods | 264 | |
|---|---|---|
| control rod rods | 25 | |
| grid pitch | 1.26 | cm |
| block dimensions | 21.5 | cm |
| fuel rod outer radius | 0.475 | cm |
| fuel pellet radius | 0.4095 | cm |
| fuel rod inner radius | 0.418 | cm |
| guide tube inner radius | 0.56 | cm |
| guide tube outer radius | 0.61 | cm |

wherein the fuel tube is a sleeve positioned between the fuel pellets and the flowing water through the reactor core 14.

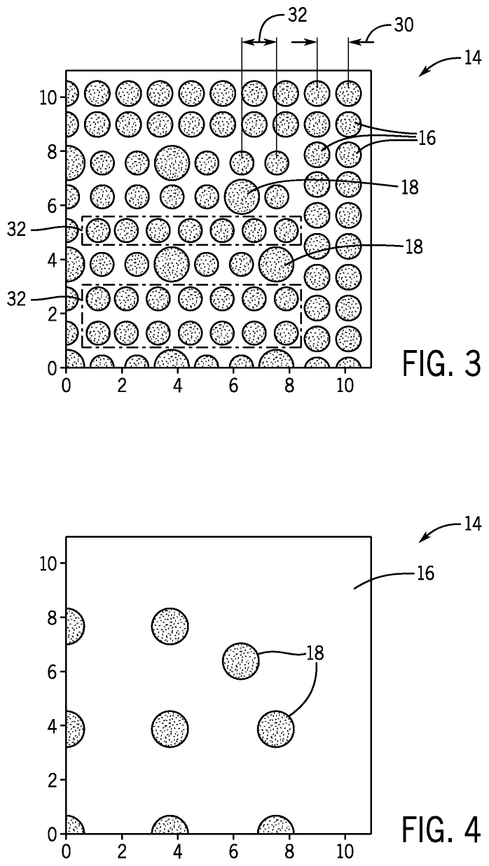

Referring now to FIG. 3, in one approach to the problem of adding additional fuel rods 16 to the reactor core 14, the spacing of peripheral fuel rods 16 forming the outermost two rows and two columns of fuel rods 16 are adjusted with a narrowed rod spacing 30 compared to the standard interrod spacing 32 found in the prior art arrangement of FIG. 2. This narrowed rod spacing 30 allows 19 fuel rod 16 to be provided in these rows and columns. Because these two rows and columns are outside the peripheral boundary of the positioning of the control rod passageways 18, this narrowed rod spacing 30 may be implemented without changing the position of the control rod passageways 18. The result of this adaptation allows an increase in the number of fuel rods 16 from 264 to 280.

In a second approach, selected rows 32 of fuel rods 16, where the narrowed rod spacing 30 would permit the introduction of additional fuel rods 16, are also given the narrower spacing 30. The result of this adaptation allows an increase in the number of fuel rods 16 from 280 to 292 compared with the first approach.

A neutronic analysis of these two approaches was performed using the OpenMC Monte Carlo code. The fission rate for the pellets in each fuel rod 16 were tallied and 500,000 particles were simulated over 100 stages, with a further 10 inactive stages to converge the source. A reflective boundary condition was used.

The result was that these two approaches had undesirable power peaking. In this respect the power peaking of the standard core assembly of FIG. 2 is 1.09 whereas the first approach above had a power peaking factor of 1.17 and the second approach had a power peaking of 1.20, strongly suggesting that improvement in core power is not readily obtained simply by adjusting the spacing of the fuel rods 16.

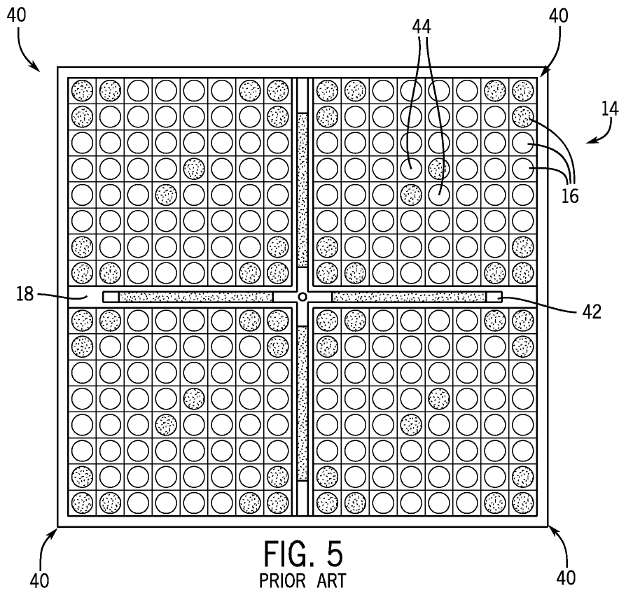

Referring now to FIG. 4, in a third approach, the above-described adjustments of the fuel rods 16 are made with the addition that constraint of the fuel rods 16 to be on a regular grid was relaxed resulting in a closer packing density of the fuel rods 16 at the corner periphery of the control rod passageways 18. Some of the fuel tubes 16 in this region were given a maximum density triangular packing pattern providing three adjacent fuel tubes 16 with equal separation and centered at vertices of an equilateral triangle.

This third approach provides a power peaking of 1.11 with 22.7 more fuel rods 16, a power peaking comparable to a standard design. The power peaking can be further improved by reducing the enrichment of the hottest fuel rods 16 from 4.95% to 4.75% providing a power peaking similar to a standard grid (1.08).

In this third approach, some of the fuel rods 16 are not on equally spaced gridlines parallel to sides of the reactor core 14 defined by the outer periphery of fuel rod 16. Nevertheless, the control rod passageways 18 are maintained at intersections of such a regular grid.

The center positions of each fuel rod 16 in this approach are given in the following Table II relative to the center of the fuel assembly.

TABLE II

| X (cm) | Y (cm) |
|---|---|
| 0 | 1.26 |
| 0 | 2.52 |
| 0 | 5.04 |
| 0 | 6.3 |
| 0 | 9.0189 |
| 0 | 10.1463 |
| 1.1274 | 1.1274 |
| 1.1274 | 2.2547 |
| 1.1274 | 3.3821 |
| 1.1274 | 4.5095 |
| 1.1274 | 5.6368 |
| 1.1274 | 6.7642 |
| 1.1274 | 7.8916 |
| 1.1274 | 9.0189 |
| 1.1274 | 10.1463 |
| 1.26 | 0 |
| 2.2547 | 1.1274 |
| 2.2547 | 2.2547 |
| 2.2547 | 3.3821 |
| 2.2547 | 4.5095 |
| 2.2547 | 5.6368 |
| 2.2547 | 6.7642 |
| 2.2547 | 7.8916 |
| 2.2547 | 9.0189 |
| 2.2547 | 10.1463 |
| 2.52 | 0 |
| 3.1566 | 5.0732 |
| 3.1566 | 6.2005 |
| 3.3821 | 1.1274 |
| 3.3821 | 2.2547 |
| 3.3821 | 9.0189 |
| 3.3821 | 10.1463 |
| 4.0585 | 5.6368 |
| 4.5095 | 1.1274 |
| 4.5095 | 2.2547 |
| 4.5095 | 9.0189 |
| 4.5095 | 10.1463 |
| 4.6222 | 4.6222 |
| 4.6368 | 6.8206 |
| 5.04 | 0 |
| 5.0732 | 3.1566 |
| 5.0732 | 8.1171 |
| 5.107 | 5.8623 |
| 5.6368 | 1.1274 |
| 5.6368 | 2.2547 |
| 5.6368 | 4.0585 |
| 5.6368 | 7.2152 |
| 5.6368 | 9.0189 |
| 5.6368 | 10.1463 |
| 5.8623 | 5.107 |
| 6.2005 | 3.1566 |
| 6.2005 | 8.1171 |
| 6.3 | 0 |
| 6.7642 | 1.1274 |
| 6.7642 | 2.2547 |
| 6.7642 | 9.0189 |
| 6.7642 | 10.1463 |
| 6.8206 | 4.6368 |
| 7.125 | 7.125 |
| 7.2152 | 5.6368 |
| 7.8916 | 1.1274 |
| 7.8916 | 2.2547 |
| 7.8916 | 7.8916 |
| 7.8916 | 9.0189 |
| 7.8916 | 10.1463 |
| 8.1171 | 5.0732 |
| 8.1171 | 6.2005 |
| 9.0189 | 0 |
| 9.0189 | 1.1274 |
| 9.0189 | 2.2547 |
| 9.0189 | 3.3821 |
| 9.0189 | 4.5095 |
| 9.0189 | 5.6368 |
| 9.0189 | 6.7642 |
| 9.0189 | 7.8916 |
| 9.0189 | 9.0189 |
| 9.0189 | 10.1463 |
| 10.1463 | 0 |
| 10.1463 | 1.1274 |
| 10.1463 | 2.2547 |
| 10.1463 | 3.3821 |
| 10.1463 | 4.5095 |
| 10.1463 | 5.6368 |
| 10.1463 | 6.7642 |
| 10.1463 | 7.8916 |
| 10.1463 | 9.0189 |

It will be generally recognized that having established the possibility of significant improvements in power output through irregular spacing, that properly constructed optimization approaches may be employed subject to the constraints described above to provide variations on this implementation and possible improvements thereto.

In each of the above approaches, the fuel pellet radius is reduced so that the fuel area is conserved. This maintains the neutronic behavior of the reactor by preserving the hydrogen to heavy metal (H/HM) ratio. The clad thickness is also reduced from 0.57 mm to 0.51 mm so that the clad area is conserved. This is deemed justified as a slightly thinner pin will have a slightly smaller internal pressure and hence require a slightly thinner clad. In the third approach of FIG. 4, this leads to a pin diameter of 0.429 cm, which is not a radical change on existing technology and significantly above the likely lower limit. Modeling of the depletion rate and assembly pressure drop of this third approach also indicates acceptable performance.

Referring now to FIGS. 5 and 6, a BWR reactor may provide fuel assemblies 15 with four fuel assemblies 40 separated by a cruciform control rod 42. Here, each quadrant 40 includes a set of fuel rods 16 and two central “water rods” 44 being cylindrical channels holding water in order to even out power distribution. In a BWR reactor, the pressure maintained in the pressure vessel 12 is insufficient to prevent boiling.

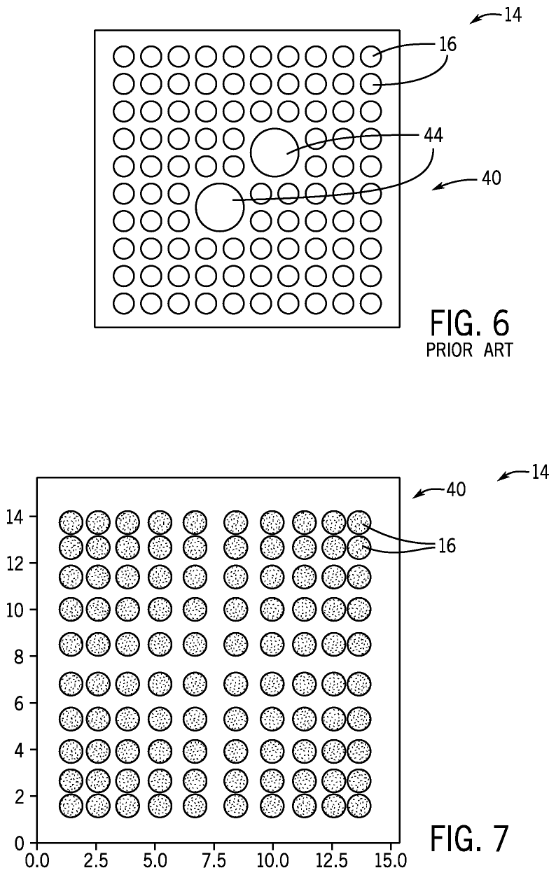

Referring now to FIG. 7, modeling has demonstrated that the water rods 44 may be eliminated by using an irregular spacing between the fuel rods 16 tending to provide greater spacing toward the center of the fuel assembly than toward its periphery while allowing the addition of more fuel rods 16.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What I claim is:

1. A nuclear reactor comprising:
a fuel assembly having:
a set of vertically oriented and horizontally spaced fuel tubes providing water passage therebetween;
a set of vertically oriented control rod passageways separating groups of the fuel tubes;
a pressure vessel surrounding the fuel assembly;
a control rod mechanism communicating through the pressure vessel to move control rods into and out of the control rod passageways;
wherein some interior fuel tubes of the fuel assembly are arranged displaced from equally spaced grid axes.

2. The nuclear reactor of claim 1 wherein a separation between a central axis of given fuel tubes adjacent to control rod passageways and central axes of adjacent neighbors to the given fuel tubes varies.

3. The nuclear reactor of claim 1 wherein the fuel tubes are cylinders of equal diameter.

4. The nuclear reactor of claim 1 wherein the nuclear reactor is a pressurized water reactor maintaining circulating water through the water passage and further providing a water circulation system for maintaining a water pressure and temperature preventing a boiling of cooling water

5. The nuclear reactor of claim 4 wherein the control rod passageways are positioned at intersections of a regular grid having equal spacing in perpendicular directions

6. The nuclear reactor of claim 5 wherein in the regular grid provides 17 intersections along each direction.

7. The nuclear reactor of claim 4 wherein a subset of fuel tubes have triangular packing providing three adjacent fuel tubes equal separation along non-perpendicular axes

8. The nuclear reactor of claim 4 wherein a number of grid tubes is greater than 300

9. The nuclear reactor of claim 4 wherein the control rod rods are positioned at positions outside of a regular grid and integer divisions thereof.

10. The nuclear reactor of claim 1 wherein the fuel tubes have a diameter of greater than 6 mm

11. The nuclear reactor of claim 1 wherein the fuel tubes are cylinders

12. The nuclear reactor of claim 1 wherein the nuclear reactor is a boiling water reactor maintaining circulating water through the water passage and further providing a water circulation system for maintaining a water pressure and temperature permitting boiling of cooling water
and wherein the fuel assembly provides water circulation through a center of the fuel assembly only within channels holding fuel tubes

13. A method of retrofitting a pressurized water reactor for increased power output comprising the steps of:
(a) removing an existing fuel assembly having a set of vertically oriented and horizontally spaced tubes arranged on a regular grid of uniformly separated gridlines and control rod passageways aligned with penetrations in a surrounding pressure vessel;
(b) installing a new fuel assembly having:
a set of vertically oriented and horizontally spaced fuel tubes providing water passage therebetween;
a set of vertically oriented control rod passageways separating groups of the fuel tubes;
wherein some center axes of the interior fuel tubes of the fuel assembly are arranged displaced from equally spaced grid axes.
